(19) United States
(12) Patent Application Publication
(10) Pub. No.: US 2021/0333565 A1
(43) Pub. Date: Oct. 28, 2021

(54) MULTI-APERTURE LASER SYSTEM

(71) Applicant: Active Fiber Systems GmbH, Jena (DE)

(72) Inventors: Bettina LIMPERT, Jena (DE); Arno KLENKE, Jena (DE); Tino ElDAM, Jena (DE)

(73) Assignee: Active Fiber Systems GmbH, Jena (DE)

(21) Appl. No.: 17/284,184

(22) PCT Filed: Oct. 9, 2019
(86) PCT No.: PCT/EP2019/077354

§ 371 Date: Apr. 9, 2021

(30) Foreign Application Priority Data
Oct. 12, 2018 (DE) 10 2018 125 356.7

(51) Int. Cl. G02B 27/10; G02B 27/14; H01S 3/067; H01S 3/00; H01S 3/23; H01S 3/13

(52) U.S. Cl. CPC G02B 27/1093; G02B 27/145; H01S 3/06758; H01S 3/1307; H01S 3/0057; H01S 3/2383; H01S 3/06716

(57) ABSTRACT

The invention relates to an optical system with a dividing element (2), which divides the input laser beam (EL) into a number of spatially separate sub-beams, at least one optical amplifier (4), through which the spatially separate sub-beams propagate, at least one path-length adjustment element (3), which adjusts the path length of at least one of the sub-beams, and a combination element (6, 8), which coherently superimposes the sub-beams in an output laser beam. The object of the invention is to achieve a high beam quality in the output laser beam, wherein the demands on the surface quality of the optical components used are to be reduced compared with the prior art. To this end the invention proposes that at least one optical functional element (5, 5′, 6′, 7) from the group of transport element, spectral broadening element, beam deflection element, optical isolator, optical modulator and pulse compressor is provided arranged after the at least one optical amplifier (4) in the beam path, through which functional element the spatially separate sub-beams propagate.

The invention relates to an optical system with
a dividing element, which divides an input laser beam into a number of spatially separate sub-beams,
at least one optical amplifier, through which the spatially separate sub-beams propagate,
at least one path-length adjustment element, which adjusts the path length of at least one of the sub-beams, and
a combination element, which coherently superimposes the sub-beams in an output beam.

The performance of optical components, e.g. of laser amplifiers, spectral broadening elements, transport fibers, optics (e.g. mirror surfaces, substrates, lenses) etc. is limited by various physical effects. A distinction should be drawn here between the average power and the pulse peak power that is important in pulsed systems. A limit is attributable to thermal effects, which occur above a certain average power and depend on the geometry of the element as well as external influences. A change in the output beam of classic solid-state lasers due to the occurrence of thermal lensing can be cited as one example of these effects. In fiber amplifiers, on the other hand, the occurrence of mode instabilities due to thermal effects constitutes a limit on the average output power attainable.

Moreover, non-linear effects such as self-phase modulation occur in the medium at high pulse peak outputs. These cause a spatial or temporal change in the phase of the laser radiation. In the time domain, an undesirable deformation of the pulse can occur for this reason, leading to a reduction in pulse quality and extension of the pulse duration, above all in pulses with a high bandwidth. In the spatial domain, these non-linear effects can lead to self-focusing of the beam, which can quickly cause destruction of the respective medium. As well as limiting the maximum possible pulse peak power in connection with a given pulse shape or pulse length, non-linear effects also cause limiting of the maximum pulse energy. In addition, the medium can be damaged at high pulse peak outputs or pulse energies, which can likewise constitute a limitation.

Non-linear effects are utilized in elements for spectral broadening. Limiting physical effects occur there also, however. If solid-state materials in the form of crystals or fibers are used as non-linear media, a limit is set for the pulse peak power above all by the self-focusing already described. If capillaries filled with inert gas are used as a non-linear medium, significantly higher pulse peak outputs are possible, these also already being attained using existing laser systems. Furthermore, the high intensity can lead to ionization of the gas, which is undesirable.

Various approaches for overcoming these limitations and for raising the average output power attainable are known from the prior art.

For example, approaches exist for avoiding limitations in relation to optical amplification and spectral broadening.

By enlarging the beam area it is possible to reduce the power density and the pulse peak intensities in the optical elements used. An example when using fiber-optic elements is the use of so-called large mode area fibers. Due to the larger beam area, this makes it possible to increase the pulse peak power accordingly without disadvantageous effects. A substantial challenge exists here, however, in maintaining a high beam quality, as with the growing size of the components (corresponding to the enlarged beam area) a sufficiently high surface quality of the optical components used can scarcely be guaranteed in practice. Deficiencies in the surface quality ultimately lead to an undesirable wavefront distortion of the laser beam.

By using circularly polarized pulses, for example, the strength of the Kerr effect, which is responsible among other things for the occurrence of self-focusing, can be reduced.

Manipulation of the spectral phases or amplitudes can compensate for a degradation of pulse quality due to non-linear effects.

In so-called chirped pulse amplification (CPA), temporal stretching of the pulses takes place prior to amplification so that the pulse peak power is reduced correspondingly during the amplification. Following amplification the pulses are temporally compressed again.

In so-called divided pulse amplification (DPA) or divided pulse nonlinear compression (DPNLC), a pulse is divided into several temporally separate pulse replicas. Following amplification or broadening of the pulses of the pulse train, recombination into one pulse takes place. Due to the temporal division, the pulse peak power of each pulse replica is smaller than that of a single pulse.

Spatially separate amplifiers or spectral broadening elements can be used, wherein splitting of the input beam by means of beam splitters into several sub-beams takes place. These are amplified or spectrally broadened in several spatially separate, independent optical elements/channels and finally combined in one beam again. A distinction is to be drawn here between combination of signals of the same or different spectra. In spectrally identical combination, the same spectral components propagate in the various channels and only one division of power takes place at the beam splitter. In spectral combination, on the other hand, further spectral division of the input laser radiation takes place in addition. Combinations of both methods are possible. In addition, the temporal phase of the individual sub-beams is of fundamental importance and must match in the sub-wavelength range. In some cases, it can be guaranteed on account of the construction that this condition is continuously fulfilled. Active stabilization of the phase may otherwise be necessary. Moreover, in pulsed operation the most precise possible temporal overlap of the individual pulses must be guaranteed upon combination. A deviation leads to a reduction in combination efficiency. With spectrally identical combination, it is additionally necessary that the individual pulses in the channels have phase and amplitude profiles that are as identical as possible. Deviations can here likewise lead to a reduction in combination efficiency (see J. Limpert, A. Klenke, M. Kienel, S. Breitkopf, T. Eidam, S. Hädrich, C. Jauregui, and A. Tunnermann, “Performance Scaling of Ultrafast Laser Systems by Coherent Addition of Femtosecond Pulses,” IEEE J. Sel. Top. Quantum Electron. 20, 268-277, 2014; Guichard, M. Hanna, L. Lombard, Y. Zaouter, C. Hönninger, F. Morin, F. Druon, E. Mottay, and P. Georges, “Two-channel pulse synthesis to overcome gain narrowing in femtosecond fiber amplifiers.,” Opt. Lett. 38, 5430-3, 2013; T. W. Hänsch and B. Couillaud, “Laser frequency stabilization by polarization spectroscopy of a reflecting reference cavity,” Opt. Commun. 35, 441-444, 1980; T. M. Shay, “Theory of electronically phased coherent beam combination without a reference beam,” Opt. Express 14, 12188-12195, 2006; A. Klenke, E. Seise, J. Limpert, and A. Tunnermann, “Basic considerations on coherent combining of ultrashort laser pulses,” Opt. Express 19, 25379-25387, 2011).

In the known techniques for spatially separate propagation or amplification of the sub-beams, a distinction is drawn in respect of the combination of the sub-beams in the output laser beam between so-called “filled aperture” and “tiled aperture” approaches. The first approach (“filled aperture”) signifies in this case the coherent superimposition of the sub-beams in the near and far field. The advantage of this approach is the high superimposition efficiency (theoretically up to 100%). A challenge is posed, however, by the necessity of one or more elements for beam superimposition, which can lead to undesirable output-dependent effects in or on these elements. In the “tiled aperture” combination, the sub-beams are composed into a new total emission. An output laser beam is thus formed artificially with an enlarged aperture which, when the single emissions of the sub-beams are superimposed in the far field, represents the diffraction pattern of the artificially formed aperture. An advantage is the possible elimination of a combination element, whereby this approach is considered output-scalable. A marked disadvantage, however, is the limited combination efficiency of typically <60%.

Various approaches are known for components for beam division and combination in connection with the “filled aperture” method. For example, beams can be divided and combined with the aid of 1:2 beam splitters. A 1:2 beam splitter can be realized with the aid of a polarization-dependent beam splitter or a partially reflective surface. A 1:N division can be realized with several of these beam splitters by cascading. The production of N sub-beams is thus possible. The same principle can also be used for combination, i.e. the superimposition of several sub-beams in an output beam. A disadvantage is that the scalability of the number of channels is made difficult by the amount of required elements (1:2 beam splitters). Thus 31 1:2 beam splitters are required for a 1:32 beam splitter, for example.

A 1:N beam splitter can alternatively be realized as a monolithic diffractive element. The individual sub-beams have an angular dispersion that is not identical for the various beams, however. The different angular dispersion must be eliminated when using ultra-short pulses by respectively adapted compensation elements. This may likewise lead to a high number of necessary elements and make scaling to a higher channel number difficult. This approach is thus likewise very costly.

Beam splitters based on reflective elements with zones of different reflectivity offer an elegant solution here. It is known from the prior art to use such elements in systems with beam division and spatially separate optical amplifiers (or spectral broadening elements) for the individual sub-beams (see A. Klenke, M. Müller, H. Stark, F. Stutzki, C. Hupel, T. Schreiber, A. Tunnermann, and J. Limpert, “Coherently combined 16-channel multicore fiber laser system,” Opt. Lett. 43, 2018).

The methods known hitherto, which are based on the spatial and/or temporal division of laser beams or pulses, aim to circumvent power limitations of optical amplifiers or spectral broadening elements. All known methods assume that following amplification and/or spectral broadening, combination of the sub-beams takes place in turn. Due to the coherent combination of the sub-beams, in particular in the case of ultra-short-pulsed laser radiation, novel parameter ranges may be feasible. Power densities arise in this case, however, which make enlargement of the beam area in the output laser beam unavoidable in order to avoid a disruptive influence on the spatial, spectral and/or temporal characteristic of the laser radiation due to non-linear effects or material modifications. The required enlargement of the beam cross section leads to ever further increasing demands on the surface quality of optical surfaces or substrates (e.g. mirrors, gratings, thin film polarizers etc.) of optical components required in the beam path between combination element and application (e.g. a workpiece to be processed). Moreover, power-limiting effects occur, e.g. ionization in gas-filled hollow-core fibers or Kerr non-linearity in air or substrates, which get in the way of practical utilization of the increased power.

Against this background, the object of the invention is to provide an optical system that is improved compared with the prior art. In particular, a high beam quality is to be achieved in the output laser beam, wherein the demands on the surface quality of the optical components used are reduced.

This object is achieved by the invention starting out from an optical system of the type specified at the beginning in that at least one optical functional element from the group of transport element, spectral broadening element, beam deflection element, optical isolator, optical modulator and pulse compressor is provided, which functional element is arranged after the at least one optical amplifier in the beam path, and through which functional element the spatially separate sub-beams propagate. The combination of the sub-beams in the output laser beam thus take place only after passing through the at least one optical functional element.

The invention is based on the fundamental idea of continuing the concept of beam division, i.e. the production of parallel propagating sub-beams, followed by coherent combination. According to the invention, however, the spatially separate propagation of the sub-beams does not end after optical amplification, but is maintained, for example, right up to the application (experiment/workpiece). No combination of the sub-beams accordingly takes place initially, but rather the individual, spatially separate sub-beams propagate through e.g. a pulse compressor, a spectral broadening element, a transport element etc. until combination ultimately takes place shortly before the beam outlet opening of the system or even directly at the location of the application.

The input laser radiation (e.g. a laser source) is split into several channels, wherein each channel is associated with a sub-beam. The number of channels N should be greater than or equal to two. Spatially separate optical amplification then takes place (e.g. by several parallel optical amplifier units). The spatially separate, amplified sub-beams are now transmitted in parallel as a multibeam array in the most compact arrangement possible through one or more functional elements of the laser system. These elements can be a pulse compressor, elements for output modulation or optical switches (e.g. electro- or acousto-optic modulators, EOMs or AOMs), optical isolators, several spatially separate elements for spectral broadening (e.g. hollow-core fibers with several cores/capillaries) as well as elements carrying the sub-beams for transporting the radiation to the application.

The advantage of this approach is that the beam areas of the individual apertures associated with the sub-beams do not have to be enlarged with the overall output. Only surface deformations on an area of the individual aperture accordingly play a role for potential impairment of the wavefront quality due to a lower surface quality of the optical components used in the beam path. This is typically excellent even for large substrates. It is only across the overall surface of a component that the surface quality cannot generally be maintained at a high level in practice. This problem is circumvented by the invention.

The deformations on the overall surface of the components used in the optical functional element act in the arrangement according to the invention purely as static path length differences and can be easily compensated for by the (in the case of N sub-beams) N-1 path-length adjustment elements, which are required in any case for coherent combination. The path-length adjustment elements thus additionally assume the tasks of segmented (spatially subdivided) adaptive optics, which correct all wavefront deformations in the overall system. Only any other optical components or substrates in the beam path behind the combination element must have an excellent surface quality.

In a preferred configuration, the dividing element and/or the combination element are formed respectively as diffractive beam splitters.

The dividing element and/or the combination element can preferably each be formed as a reflective element with zones of different reflectivity, as known in principle from the prior art. It is particularly preferable that the dividing element and/or the combination element each comprise two or more reflective elements at which the laser radiation is reflected successively single or multiple times, wherein the sub-beams form a two-dimensional array in a plane transverse to the propagation direction. A more compact parallel beam path of the sub-beams can be realized thus.

In another preferred configuration, a error signal detector is provided, which derives a error signal from the output laser beam or from the sub-beams, and a controller, which derives from the error signal at least one control signal for controlling the at least one path-length adjustment element. This control circuit can be used advantageously for active control of the coherent superimposition in the output laser beam. The control can take place e.g. according to the known LOCSET principle or by sequential phase stabilization (see A. Klenke, M. Müller, H. Stark, A. Tunnermann, and J. Limpert, “Sequential phase locking scheme for a filled aperture intensity coherent combination of beam arrays”, Opt. Express 9, 12072-12080, 2018).

The at least one optical amplifier can advantageously be an optically pumped multicore waveguide, which is doped with rare earth ions and in which a plurality of waveguide structures is integrated, wherein each waveguide structure carries one of the sub-beams. A particularly compact construction can thus be realized. Any (thermal or acoustic) disturbances affect all sub-beams in substantially the same way, so that coherent superimposition is scarcely impaired in the output beam. The amplifier can also be a volume-optical amplifier without waveguide structure, however, in which all or a portion of the sub-beams propagate.

The at least one path-length adjustment element should be arranged in the beam path ahead of the at least one optical amplifier. Thus the path-length adjustment element does not have to be rated for high outputs.

The spectral broadening element, like the transport element, can also be a multicore waveguide in which a plurality of waveguide structures is integrated, wherein each waveguide structure carries one of the sub-beams. Alternatively, the spectral broadening element can be a volume-optical element without waveguide structure.

Exemplary embodiments of the invention are explained below with reference to the drawings. There is shown:

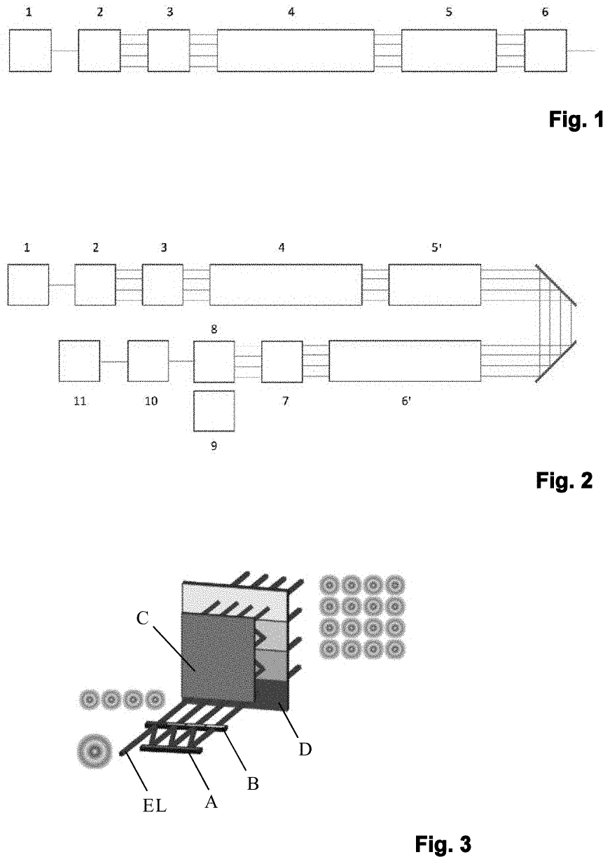

FIG. 1 a schematic depiction of an optical system according to the invention as a block diagram;

FIG. 2 a schematic depiction of an optical system according to the invention in another configuration as a block diagram;

FIG. 3 a dividing and combination element based on multiple reflection.

In the exemplary embodiment of FIG. 1, an input laser beam coming from a laser source 1 is divided into N channels. An arrangement of partially reflective mirrors or polarized beam splitters in a cascaded arrangement, diffractive elements or an arrangement of mirrors with zones of different reflectivity (see below) can be used as a dividing element 2 for this. The N spatially separate sub-beams are now spatially separately amplified by means of an optical amplifier 4. Classic individual amplifiers (e.g. fiber-based amplifiers) can be used for this or one or more multicore fibers, which implement the concept of spatially separate amplification in a compact manner. The necessary path-length adjustment elements 3 for controlling the coherent combination are ideally located in the beam path behind the dividing element 2 and ahead of the optical amplifier 4. Piezo elements, for example, EOMs or optical wedges movable via actuators are possible for this.

If the system is a continuously (cw) emitting laser system, spatially separate propagation of the sub-beams (multi-aperture emission) can now take place directly up to the application. Elements for beam deflection (e.g. scanners, acousto-optic deflectors etc.) and elements for output modulation (shutters, EOMs, AOMs etc.) or fiber-optic transport fibers (e.g. multicore fibers or multicore hollow-core fibers) are penetrated by the multi-aperture emission. These elements are summarized by the reference character 5. These elements are optical functional elements in the sense of the invention. It is also possible in this case that the deflection or modulation acts only on a portion of the sub-beams. The sub-beams are superimposed and coherently combined only shortly before the application (“filled aperture” combination), to be precise by means of a combination element 6, which is constructed in a complementary manner to the dividing element 2. Let a “tiled aperture” combination be explicitly excluded here.

If the system is a pulsed and in particular an ultra-short-pulsed laser system, the approach according to the invention has other advantages compared with the prior art. Following division and spatially separate amplification, the spatially separate, yet extremely compactly arranged sub-beams propagate through a pulse compressor (e.g. grating arrangement) as an optical functional element 5. The sub-beams do not exceed the thresholds of material destruction or non-linear pulse or beam degradation here, as the surface scaling succeeds via the division into sub-beams. Following pulse compression, beam combination can take place. The spatially separate sub-beams can likewise each experience spectral broadening beforehand. This is done, for example, in spatially separately arranged waveguides (e.g. glass fibers or gas-filled hollow-core fibers). The now spectrally broadened sub-beams can then be individually compressed (e.g. by chirped mirrors) or propagate spatially separately as far as the application. Instead of the spectral broadening or in addition to this, other elements for beam or pulse modification can be passed through. Elements for pulse selection, pulse or output modulation or beam deflection are conceivable. These functionalities are summarized in FIG. 1 as a whole by reference character 5. The amplified, if applicable spectrally broadened and modulated pulses can now propagate as far as the application as spatially separate and collimated sub-beams before coherent combination finally takes place according to the “filled aperture” principle in 6.

In the exemplary embodiment of FIG. 2, a rare-earth-doped multicore fiber (core number=N) is used as an optical multichannel amplifier 4. Division into N sub-beams following the laser source 1 is achieved by the use of a mirror arrangement 2 (see FIG. 3) based on reflectors with zones of different reflectivity, which can generate a high number of sub-beams in a compact design. The N-1 path-length adjustment elements are realized by a piezo array 3, which is adapted in its arrangement to the geometry of the sub-beams. The emitted laser radiation of the amplifying multicore fibers 4 is collimated and the resulting beam bundle passes through a grating compressor 5′. After the grating compressor 5′, spectral broadening takes place in a passive multicore fiber or gas-filled multi-hollow-core fiber 6′. To this end the sub-beam array from the amplifying multicore fiber 4 can be replicated, after passing through the grating compressor 5′, directly into the multicore broadening fiber 6′. Multi-aperture propagation takes place at 7, e.g. to bridge the distance to the application 11 and/or to insert a power modulation or beam deflection. For coherent combination, a small fraction of the multi-aperture emission is diverted onto a photodiode array 9 for detecting a error signal. A controller (not shown) calculates the necessary corrections by the path-length adjustment elements 3 from this. Immediately before the application 11, beam combination takes place at 8. Pulse compression by means of chirped mirrors follows at 10.

FIG. 3 shows a dividing and combination element based on multiple reflection such as can be used in the exemplary embodiments in FIGS. 1 and 2.

The element consists of four sub-elements A, B, C, D. The first sub-element A is a mirror with the highest possible reflectivity. The second sub-element B comprises (in the example depicted) four zones of different reflectivity. The laser beams take the path depicted in FIG. 3. The reflectivities of the zones of the sub-element B can be selected such that the incident input laser beam EL is divided into sub-beams in a certain ratio. One example is division into equal portions to all sub-beams. This is achieved by selecting the reflectivities of the four zones at 75%, 66%, 50% and 0%. The exiting four sub-beams then fall on plane-parallel surfaces of the two sub-elements C and D, which are tilted towards the sub-elements A, B. The sub-element C is again highly reflective. The sub-element D comprises in turn four zones of different reflectivity (as before). As a result, as depicted, a two-dimensional array of 16 sub-beams is generated in a plane perpendicular to the beam path. The number of zones of different reflectivity can be arbitrary in the case of sub-elements B and D according to the desired number of sub-beams, i.e. according to the division ratio.

The combination element can, as said previously, be implemented identically and arranged in the manner that the resulting path length differences of the 16 sub-beams precisely cancel one another out. Due to the integration of division and combination in a single element, a compact design is possible, and simple adjustment is guaranteed. Nor does any angular dependence of the sub-beams on the wavelength exist, the element is thus also suitable for spectrally broadband radiation and thus for the use for ultra-short pulses.

1. Optical system, comprising
a dividing element, arranged to divide an input laser beam into a number of spatially separate sub-beams,
at least one optical amplifier, through which the spatially separate sub-beams propagate,
at least one path-length adjustment element, which is arranged to adjust the path length of at least one of the sub-beams, and
a combination element, arranged to coherently superimposes the sub-beams in an output laser beam, wherein at least one optical functional element from the group of transport element, spectral broadening element, beam deflection element, optical isolator, optical modulator and pulse compressor arranged after the at least one optical amplifier in the beam path, through which functional element the spatially separate sub-beams propagate.

2. Optical system according to claim 1, wherein the dividing element and/or the combination element are each formed as diffractive beam splitters.

3. Optical system according to claim 1, wherein the dividing element and/or the combination element are each formed as a reflective element with zones of different reflectivity.

4. Optical system according to claim 3, wherein the dividing element and/or the combination element each comprise two or more reflective elements at which the laser radiation is reflected consecutively one or multiple times.

5. Optical system according to claim 1, wherein the sub-beams form a two-dimensional array in a plane transverse to the propagation direction.

6. Optical system according to claim 1, wherein provision is made for an error signal detector, which is arranged to derive an error signal from the output laser beam or from the sub-beams, and a controller, which is arranged to derive from the error signal at least one control signal to control the at least one path-length adjustment element.

7. Optical system according to claim 1, wherein the at least one optical amplifier is an optically pumped multicore waveguide, which is doped with rare earth ions and in which a plurality of waveguide structures is integrated, wherein each waveguide structure is arranged to carry one of the sub-beams.

8. Optical system according to claim 1, wherein the at least one path-length adjustment element is arranged ahead of the at least one optical amplifier in the beam path.

9. Optical system according to claim 1, wherein the combination element is located at the location of the application of the output laser beam.

10. Optical system according to claim 1, wherein the pulse compressor is an arrangement of one or more grating pairs or prism pairs, wherein each grating or prism pair is penetrated by each of the spatially separate sub-beams single or multiple times.

11. Optical system according to claim 1, wherein the spectral broadening element is a multicore waveguide in which a plurality of waveguide structures is integrated, wherein each waveguide structure carries one of the sub-beams.

12. Optical system according to claim 1, wherein the transport element is a multicore waveguide in which a plurality of waveguide structures is integrated, wherein each waveguide structure carries one of the sub-beams.
